(19) United States
(12) Patent Application Publication
(10) Pub. No.: US 2022/0138607 A1
(43) Pub. Date: May 5, 2022

(54) METHODS AND APPARATUS FOR IMPROVING SIGNAL-TO-NOISE PERFORMANCE IN QUANTUM COMPUTATION

(71) Applicant: River Lane Research Ltd., Cambridge (GB)

(72) Inventors: Joan CAMPS, Cambridge (GB); Dan UNDERWOOD, Cambridge (GB)

(21) Appl. No.: 16/949,556

(22) Filed: Nov. 3, 2020

(51) Int. Cl. G06N 10/00; G06F 15/16

(52) U.S. Cl. CPC G06N 10/00; G06F 15/16

(57) ABSTRACT

A computing system can be configured to determine a quantum circuit architecture, for a quantum computer, based on a physical system comprising a plurality of fermions. The computing system can comprise a classical computing system configured to: receive a reference quantum state for the physical; receive a cut-off energy; determine a Fermionic Unitary Operator based on a parameter dependent Fermionic operator, wherein the parameter dependent Fermionic operator comprises a sum of products of: an operator string with a parameter for the operator string. Each operator string of the sum of products has a transition energy less than the cut-off energy. The quantum circuit architecture can be based on the Fermionic Unitary Operator.

### FIELD

The present disclosure relates to apparatus, systems and methods for configuring quantum circuitry within a quantum computer which can improve signal-to-noise performance, in particular, although not necessarily, for performing quantum computational chemistry calculations.

### BACKGROUND

Quantum computers are expected to solve problems that are either intractable or impossible for classical computers. In some examples, superior resource allocation and overall performance may be achieved by using a classical computer for certain tasks while performing other tasks with a quantum computer. In some examples, appropriate use of a classical computer to control a quantum computer can enable the quantum computer to provide an output with an improved signal to noise characteristics.

One of the most promising applications of near-term quantum computation is quantum chemistry. An important problem in quantum chemistry is finding the state of least energy of a system (e.g. a molecule or the unit cell of a crystalline material). This problem has applications in drug discovery, catalyst development, and materials development. A standard algorithm for solving this problem on a quantum computer is the Variational Quantum Eigensolver (VQE). This algorithm searches classically for the state of least energy in a parametrised subspace of the space of quantum states of the quantum system. This is the subspace of quantum states that can be prepared with a class of quantum circuits.

For optimal performance of the VQE algorithm, it is of vital importance to work in a small parameter subspace of the true space of states, but one that gives an accurate enough estimate of the true ground state of the system. This involves a trade-off because accuracy can always be improved by enlarging the subspace.

Identifying and selecting suitable subspaces for VQE therefore has a profound impact on the near-term applications of quantum computation systems and algorithms.

### SUMMARY

According to a first aspect of the present disclosure there is provided a computing system for determining a quantum circuit architecture, for a quantum computer, based on a physical system comprising a plurality of fermions. The computing system comprises a classical computing system configured to: receive a reference quantum state for the physical system in which the plurality of fermions occupy a first set of single-particle quantum states of the physical system and in which a second set of single-particle quantum states are unoccupied. The classical computing system is configured to receive a cut-off energy that is greater than an absolute value of a difference between (i) a sum of energies of the second set of single-particle quantum states, and (ii) a sum of energies of the first set of single-particle quantum states. The classical computing system is configured to determine a Fermionic Unitary Operator based on a parameter dependent Fermionic operator. The parameter dependent Fermionic operator comprises a sum of products of: (i) an operator string; with (ii) a parameter for the operator string. Each operator string of the sum of products is formed from respective creation and annihilation operators and is associated with a respective transition of one or more of the plurality of fermions from the first set of single-particle quantum states to one or more of the second set of single-particle quantum states, each respective transition having an energy less than the cut-off energy. The classical computing system is configured to determine the quantum circuit architecture based on the Fermionic Unitary Operator.

Determining a Fermionic Unitary Operator and corresponding quantum circuit in this way results in circuits known as Energy-ordered-Unitary-Coupled-Cluster (E-UCC) circuits. Compared to the commonly used unitary-coupled-cluster singles-doubles (UCCSD) subspace, E-UCC can be more efficient (requiring fewer parameters) and accurate when performing processes such as VQE.

The benefits of E-UCC circuits manifest at the architecture level of the quantum computer and are not specific to a particular problem or application. The system of the first aspect operates in a new way in the sense that the actual physical quantum operations that are performed (i.e. the determined quantum circuit architecture) are different to those which were previously known. Moreover, the system runs more efficiently and effectively as a computing system because fewer parameters may be required for a given accuracy when optimising over the subspace.

The cut-off energy can advantageously be varied in order to improve the signal to noise ratio of qubit measurement values. By varying the cut-off energy it is possible to determine an improved (or even optimised) choice of energy cut-off to balance the accuracy of the measurement against the need to avoid excessive noise.

Optionally the energy for each respective transition may be determined using a Hartree-Fock method.

Optionally the energy of each of a plurality of operator strings of the sum of products may be an equal energy and the parameter for each respective operator string of the plurality of operator strings may be proportional to each other.

Optionally one or more operator strings of the sum of products may be formed such that one or more quantum numbers, corresponding to symmetries of a Hamiltonian of the physical system, are conserved. There may be several such sets of operator strings such that in each set all operators have the same energy and their coefficients are proportional.

Optionally the quantum circuit architecture may comprise a plurality of quantum circuits, each quantum circuit of the quantum circuit architecture having a respective design that represents the Fermionic Unitary Operator having a value for each parameter for each respective operator string.

Optionally the classical computing system may be configured to transmit a quantum circuit design of the quantum circuit architecture to the quantum computer to enable configuration of the quantum circuit and application of the quantum circuit to a quantum memory comprising an initial quantum state stored in a plurality of qubits of the quantum computer. The initial quantum state may be the same as the reference state, or it may be some other quantum state. One skilled in the art will appreciate that the exact nature of the initial state will depend on the problem being solved.

Optionally the quantum computer may be configured to: receive the quantum circuit design; configure a quantum circuit according to the quantum circuit design; apply the quantum circuit to the quantum memory containing the initial quantum state; determine a plurality of qubit measurement values of the plurality of qubits; and transmit the plurality of qubit measurement values to the classical computing system.

Optionally the classical computing system may be configured to estimate an expectation value of a quantum mechanical operator of the physical system based on the plurality of qubit measurement values.

Optionally the classical computer may be configured to vary the parameter for one or more of the operator strings and estimate an optimized-eigenvalue of the quantum mechanical operator by successively controlling the quantum computer to prepare one or more varied quantum circuits of the quantum circuit architecture and apply each in turn of the one or more varied quantum circuits to the quantum memory containing the initial quantum state.

Optionally the quantum mechanical operator may be a Hamiltonian operator.

Optionally the cut-off energy may be chosen such that a difference between an expectation value of the Hamiltonian operator and a Full Configuration Interaction energy of the physical system is less than a predetermined target, for example 4.36×10⁻²¹ J.

Optionally the Fermionic Unitary Operator may be an exponential of an Anti-Hermitian operator based on the parameter dependent Fermionic operator. For example, the Anti-Hermitian operator may be T−T^{†}, where T is the parameter dependent Fermion operator.

Optionally the reference quantum state may be a Hartree-Fock quantum state.

Optionally the plurality of fermions may be a plurality of electrons and the physical system may be a molecular system or a unit cell of a crystalline material.

Optionally the computing system may be configured to perform any one or more of catalyst development, drug discovery or materials development.

Optionally the plurality of fermions may be a plurality of nucleons.

According to a further aspect of the present disclosure there is provided a computer-implemented method for determining a quantum circuit architecture, for a quantum computer, based on a physical system comprising a plurality of fermions. The method comprises: receiving a reference quantum state for the physical system in which the plurality of fermions occupy a first set of single-particle quantum states of the physical system and in which a second set of single-particle quantum states are unoccupied; receiving a cut-off energy that is greater than an absolute value of a difference between (i) a sum of energies of the second set of single-particle quantum states, and (ii) a sum of energies of the first set of single-particle quantum states; determining a Fermionic Unitary Operator based on a parameter dependent Fermionic operator, wherein the parameter dependent Fermionic operator comprises a sum of products of: (i) an operator string; with (ii) a parameter for the operator string. Each operator string of the sum of products is formed from respective creation and annihilation operators and is associated with a respective excitation of one or more of the plurality of fermions from the first set of single-particle quantum states to one or more of the second set of single-particle quantum states, each respective excitation having an excitation energy less than the cut-off energy. The method may determine the quantum circuit architecture based on the Fermionic Unitary Operator.

According to a further aspect of the present disclosure there is provided a method for determining control signalling for a quantum computer, the control signalling configured to execute application software on the quantum computer, the application software representative of a Unitary Operator configured to operate on a wavefunction based on a physical system comprising a plurality of fermions. The method comprises: receiving a reference signal representative of a reference quantum state for the physical system in which the plurality of fermions occupies a first set of single-particle quantum states of the physical system and in which a second set of single-particle quantum states are unoccupied; receiving a cut-off signal representative of a cut-off energy that is greater than an absolute value of a difference between (i) a sum of energies of the second set of single-particle quantum states, and (ii) a sum of energies of the first set of single-particle quantum states; determining a Fermionic Unitary Operator based on a parameter dependent Fermionic operator, wherein the parameter dependent Fermionic operator comprises a sum of products of: (i) an operator string; with (ii) a parameter for the operator string; wherein each operator string of the sum of products is formed from respective creation and annihilation operators and is associated with a respective excitation of one or more of the plurality of fermions from the first set of single-particle quantum states to one or more of the second set of single-particle quantum states, each respective excitation having an excitation energy less than the cut-off energy. The method determines the control signalling based on the Fermionic Unitary Operator, wherein the Fermionic Unitary Operator is representative of the Unitary Operator.

Optionally the method may further comprise: providing the control signalling to the quantum computer; configuring the quantum computer based on the control signalling; and measuring a quantum memory of the quantum computer to provide output signalling based on the control signalling.

Optionally the method may further comprise iteratively varying the cut-off energy to improve a signal-to-noise ratio of the output signalling.

According to a further aspect of the present disclosure there is provided a computer program product, or a computer readable memory medium, including one or more sequences of one or more instructions which, when executed by one or more processors, cause an apparatus to at least perform the steps of any method disclosed herein.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The Figures and Detailed Description that follow also exemplify various example embodiments. Various example embodiments may be more completely understood in consideration of the following Detailed Description in connection with the accompanying Drawings.

### BRIEF DESCRIPTION OF DRAWINGS

One or more embodiments will now be described by way of example only with reference to the accompanying Drawings in which:

FIG. 1 shows an example embodiment of a classical/quantum computing system;

FIG. 2 shows a schematic representation of a quantum software execution process;

FIG. 3 shows an example embodiment of a flow diagram of part of the method of FIG. 2 in greater detail;

FIG. 4 shows a schematic illustration of a variational quantum eigensolver;

FIG. 5 shows an example embodiment of a flow diagram of a method for determining a quantum circuit architecture;

FIG. 6 shows example embodiments of schematic representations of unitary operators and mappings between unitary operators in physical and qubit Hilbert spaces;

FIG. 7 shows an example embodiment of a schematic representation of an energy cut-off for determining a unitary ansatz operator;

FIG. 8 shows an example embodiment similar to that of FIG. 7, but with a larger value of the energy cut-off; and

FIG. 9 shows an example embodiment of a computer program product.

### DETAILED DESCRIPTION

Quantum computers may be able to solve problems that are either intractable or impossible for classical computers. In some examples, superior resource allocation and overall performance may be achieved by using a classical computer for certain tasks while performing other tasks with a quantum computer. In some examples, appropriate use of a classical computer to control a quantum computer can enable the quantum computer to provide an output with an improved signal to noise characteristics. Embodiments of the present disclosure address the general technical problem of how to improve the signal to noise characteristics of quantum computers and in particular the signal to noise characteristics of output from quantum memories.

One of the most promising applications of near-term quantum computation is quantum chemistry. An important problem in quantum chemistry is finding the state of least energy of a system (e.g. a molecule or the unit cell of a crystalline material). This problem has applications in drug discovery, catalyst development, and materials development. A standard algorithm for solving this problem on a quantum computer is the Variational Quantum Eigensolver (VQE). This algorithm searches classically for the state of least energy in a parametrised subspace of the space of quantum states of the quantum system. This is the subspace of quantum states that can be prepared with a class of quantum circuits.

The reasons why VQE searches for the state of least energy in a subspace of states, rather than the whole space, are (i) the space of quantum states (viz quantum circuits) is so large that it is impractical to describe all quantum states within it, (ii) even if it were possible to describe all states, the classical optimisation of a state can be exponentially costly with the size of the space, making it unfeasible to optimise in large spaces, and (iii) long circuits will be too noisy. The drawback of working in a subspace is that the least energy state of that subspace and the true state of least-energy of the system may be too different. If so, this can always be ameliorated by enlarging the subspace: this enlargement always results in a better approximation to the true ground state, at the cost of longer computational runs and increased noise.

For optimal performance of the VQE algorithm, it is of vital importance to work in a small parameter subspace of the true space of states, but one that gives an accurate enough estimate of the true ground state of the system. This involves a trade-off because accuracy can always be improved by enlarging the subspace. For chemistry applications, the standard of accuracy for energy calculations is 1 kcal/mol, which is called “chemical accuracy”.

A commonly used subspace is the so-called UCCSD (unitary-coupled-cluster singles-doubles). This is the subspace of all quantum states with up to two excitations from a reference state. For many molecules this subspace does not result in chemical accuracy. To achieve chemical accuracy it can be necessary to add so-called ‘triples’ (T), ‘quadruples’ (Q), or higher excitations. This makes finding the least energy state of the subspace more computationally costly.

The present disclosure relates to an Energy-ordered-Unitary-Coupled-Cluster (E-UCC): this provides a method to define a subspace of states in which to find the least energy state. In E-UCC, the search subspace is not defined by the number of excitations with respect to a reference state, but rather by the energy difference between the states and the reference state. This energy difference may be calculated cheaply with computational chemistry tools, such as the Hartree-Fock method.

The E-UCC can be more efficient and accurate than UCCSD(TQ . . . ) method. For example, for the linear BeH₂ molecule, UCCSD is 23-dimensional and does not achieve chemical accuracy, while E-UCC, with 22 parameters, does achieve chemical accuracy.

E-UCC provides a quantum circuit architecture for VQE: the parametrised subspaces above can be viewed as “classes of quantum circuits.” In this view, the VQE algorithm can find the optimal quantum circuit from a class of circuits. Quantum circuits in one class all have a similar architecture. E-UCC defines a new class of circuits, with a new type of architecture, in which all elementary operations have energy below a threshold.

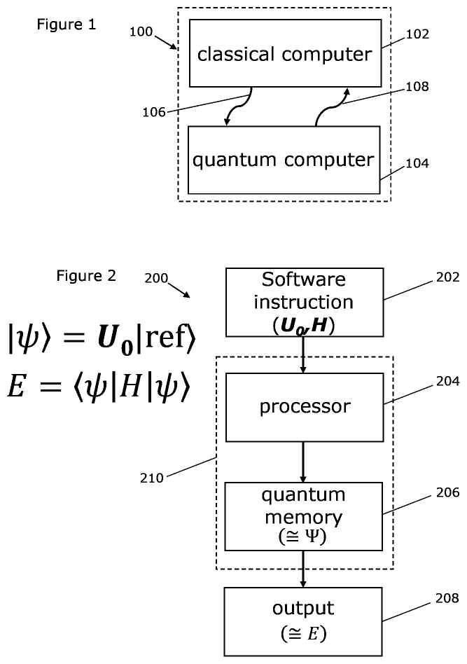

FIG. 1 shows a computer system 100 that comprises a classical computer 102 and a quantum computer 104. The classical computer 102 is operatively coupled to the quantum computer 104, such that information can be sent 106 from the classical computer 102 to the quantum computer 104 while other information can be sent 108 from the quantum computer 104 to the classical computer 102. In some examples the computer system 100 may be a single apparatus, while in other examples the computer system 100 may be a distributed system, in which the classical computer 102 is disposed at a different location than the quantum computer 104, but where the classical computer 102 and the quantum computer 104 are connected by a suitable network, such as the internet.

A task that the classical computer 102 may perform is to provide a control system for controlling the quantum computer 104, and in particular for manipulating the quantum states of qubits within a quantum memory of the quantum computer 104. It will be appreciated that the details of how qubits can be manipulated varies enormously according to the physical implementation chosen. For example, a trapped ion quantum computer will initialize, manipulate and ultimately measure the qubits using lasers. Alternatively, a Josephson junction-based quantum computer may use microwave frequency electronics to achieve the necessary manipulations required to undertake the information processing within the quantum computer's qubits. However, all quantum computers are subject to physical limitations imposed by the finite coherence times of their qubits and in the execution of the circuit on the qubits. Improved control methods and/or circuits for controlling quantum computers, and particularly quantum memories, are disclosed herein.

FIG. 2 is a schematic representation of a quantum software execution process 200. The software has a software instruction 202 having two parts: the preparation of a quantum state in quantum memory via the application of the unitary operator Uo to a reference state, and the measurement of a quantum observable H on the quantum state prepared by Uo. It will be understood that measuring the quantum observable H may require acting additional gates on the state prepared by Uo, as well as multiple runs of the preparation. The operators Uo and H represent the calculation to be performed on the quantum computer (i.e. a problem to be solved).

It will be appreciated that the unitary operator Uo may need compilation down to a quantum circuit constructed from the elementary native quantum operations permitted by the specific quantum hardware implementation. This compilation is carried out by a processor 204. In quantum computation compilation is generally approximate, and because quantum memory is fundamentally an analogue system, the application of a compiled circuit into quantum memory will generally incur rounding errors. More accurate compilations of the unitary operator Uo will generally require deeper quantum circuits, which result in a higher number of errors and thus poorer signal/noise ratios. Therefore, there is a trade-off between the accuracy of the compilation of an operator Uo and the signal/noise ratio of the compiled circuit.

The processor 204 can also be idealised as implementing the quantum circuit on quantum memory 206, which may initially be in a reference state such as the computational zero state. The processor 204 and quantum memory 206 together form a quantum processing portion of the software execution process (i.e. the processor 204 and quantum memory 206 can be considered to be a quantum processing unit or QPU). The output 208 of running the quantum software may be a number—e.g., the expectation value of the quantum observable H (after, possibly, some classical post-processing).

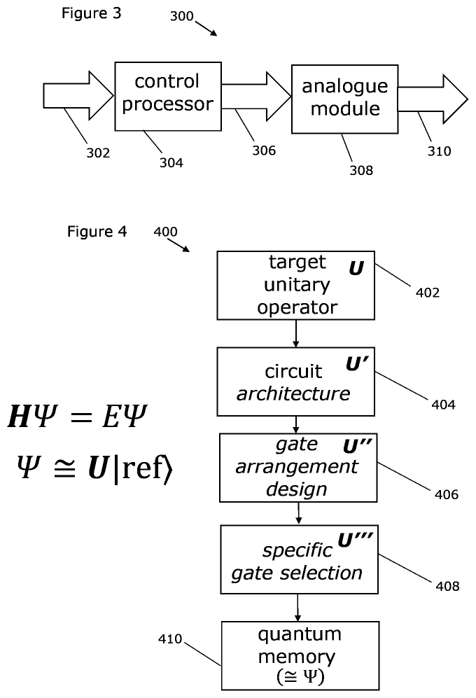

FIG. 3 shows a flow diagram 300 representing the generation of control signals in the quantum processing portion 210 of FIG. 2. The flow diagram 300 represents a signal chain flowing through a control processor 304 and an analogue module 308 (such as a waveform generator).

The control processor 304 receives and processes a control signal 302 to provide control signalling 306 to the analogue module 308, which in turn produces output signalling 310 for effecting operations on one or more qubits. The output signalling 310 may take the form of a pulse sequence to be applied to qubits in the quantum memory 206 of FIG. 2 in order to perform unitary operations on the qubits.

While quantum computing processes are often described in terms of circuits formed of logic gates, such circuits do not necessarily describe the actual operations that are performed on the qubits at a physical level. For example, rather than using the analogue model 308 to generate a series of pulses corresponding to respective logic gates, the control processor may instead provide control signalling 306 to the analogue module 308 that causes it to generate one or more pulse sequences that have (approximately) the same effect on the qubits as performing a series of quantum gates but without those gates having to be explicitly performed.

It will be appreciated that methods of the present disclosure may result in different control information/signalling being provided to different hardware quantum computers to tackle the same problem, because different hardware quantum computers can have a different balance of physical characteristics when compared with one another. The exact form of the output signalling 310 will depend on the physical system being used to perform the quantum process.

Methods of the present disclosure provide improved control signalling 306 such that an improved balance between precision and complexity of the manipulation of qubits within the quantum memory provides for improved signal to noise characteristics of the output signalling 310.

FIG. 4 is a schematic illustration of a VQE 400 for approximating a potentially unknown target unitary U 402 that, when applied to a reference state |ref [symbol] (e.g. the Hartree-Fock state), prepares a certain target state (e.g. the ground state of a Hamiltonian operator H). The VQE determines an optimal quantum circuit U′″ 408 approximating the target unitary U within a quantum architecture U′ 404. The quantum circuit architecture U′404 can be described as a parameter-dependent set of unitary operators that, upon compilation, produces a parameter-dependent set of quantum circuits U″ 406. In the example in which U 402 prepares the ground state of a Hamiltonian H from a reference state |ref [symbol] , the VQE method approximates the unknown target operator U 402 by optimising the parameters of the quantum circuits U″ 406 so that the expectation value of the Hamiltonian operator H is minimal on the state U′″|ref [symbol] . The specific gate selection U′″ 408 can be applied to the quantum memory 410.

It will be appreciated that the compilation of the unitary operators in U′ down to quantum circuits in U″ is subject to the signal/noise ratio trade-offs discussed for FIG. 2. On top of these compilation trade-offs, in the VQE, there is another source of signal/noise trade-offs, related to the choice of the quantum circuit architecture U′. On the one hand, in general, enlarging the set U′ by adding parameters will result in deeper compiled circuits U″, with poorer signal/noise ratios, and to a lengthier optimisation process for finding the optimal U′″ in U″. On the other hand, any enlargement of the set U′ will generally result in a lower energy state prepared by the action of U′″ on the reference state, and thus a better approximation to the unknown U. Different quantum circuit architectures U′ result in different signal/noise ratios, as measured by how good an approximation to the unknown U is U′″, given the number of parameters of U′ or the depth of the circuits U″.

Compared to existing architectures, the E-UCC quantum circuit architecture U′ used in the present disclosure results in an improved signal/noise ratio in the sense discussed in the preceding paragraph.

For a given hardware implementation of quantum memory, methods of the present disclosure may enable some complicated unitary/Hermitian operators to be executed successfully where known methods would fail, using the same hardware, due to errors and/or decoherence effects causing unacceptably poor signal to noise ratios. In other examples, methods of the present disclosure may provide for a more precise representation of the target unitary operators, and consequently a more accurate implementation of the target unitary operators on the qubits than previous methods could provide for using the same hardware. Thereby, methods of the present disclosure may provide more precise outputs, such as more accurate estimates of energy eigenvalues, because the signal to noise ratio of the output is improved. Methods of the present disclosure provide an improved control system, or a key component of an improved quantum computer operating system, for running given target unitary operators on any given quantum computer hardware than has previously been possible. In this way, quantum computer hardware may be utilized to provide outputs with superior accuracy compared to known methods, or where no meaningful output could previously have been obtained at all.

For any problem that a quantum computer may be configured to solve, it may be necessary to manipulate qubits into a state representative of the problem to be solved, before further manipulations can be applied to solve the problem. For example, if the problem relates to quantum computational chemistry calculations, then an ideal state for the qubits could correspond to the action of a unitary operator U on an initial reference state |ref [symbol] of the qubits. This ideal unitary operator U might configure the qubits into a state corresponding to the Full Configuration Interaction solution of the Schrodinger equation for any quantum system of interest. This ideal state could correspond to the actual ground state of the Schrodinger equation for the quantum system of interest. However, given the finite precision with which qubits can be manipulated, the application of the unitary operator U to the qubits may not be practicable or even possible. Furthermore, the exact form of this ideal unitary operator U will not in general be known in advance. Having defined a problem to be solved, it is therefore necessary to develop a series of approximations to determine how to manipulate the qubits of any particular physical quantum computer to solve the problem to a desired degree of accuracy.

To determine the control system/coding to manipulate qubits to solve a particular problem it may be possible to determine a unitary (ansatz) operator U′, which can be described as defining a quantum circuit architecture. The unitary (ansatz) operator U′ will generally be parameter dependent, with a particular set of parameters defining the operator relevant to a particular problem. The variability of the parameters means that the quantum circuit architecture does not simply define a single specific unitary operator, but rather a class or set of unitary operators, the specific characteristics of which depends on the parameters. Given a particular parameter set, the unitary (ansatz) operator U′ might render the qubits into a state that would correspond to a different quantum state than the ideal unitary operator U would provide, but which can be considered to be an approximation to the state provided by U because it may enable the quantum computer to obtain approximate solutions to the overall problem to within a useful level of accuracy. It will be appreciated that a variational procedure may be used to determine specific parameter values for a particular problem, such as the method known as the Variational Quantum Eigensolver which may be used for quantum computational chemistry calculations.

Having defined a unitary (ansatz) operator U′ it is then possible to determine a compiled quantum circuit U″ which provides restrictions on the selection and structural combinations of quantum gates that may be used to apply the unitary operator U′ to the qubits. Finally, for a given problem, such a performing quantum computational chemistry calculations for a specific molecule or other quantum system, variable parameters present in the unitary (ansatz) operator U′, and therefore also present in the compiled quantum circuit U″, may be fixed to particular values relevant to the particular problem. This step can define the exact set and structural arrangement of quantum gates required to manipulate the qubits to tackle the problem in question. This exact set and structural arrangement of quantum gates may be called a specific gate selection U′″. Variational methods, such as the Variational Quantum Eigensolver, may be used to determine the parameters required to fix the specific gate selection U′″.

As discussed above, the quantum circuit architecture U′ to be optimised represents the unitary operator U. The quantum circuit architecture U′ is defined by a set of parameter-dependent unitary operators and provides a first level of generality in determining how to represent the unitary operator U in terms of control signalling for the quantum memory. The quantum circuit architecture U′ defines the possible set of compiled quantum circuits U″. The set of quantum circuits U″ is also representative of the unitary operator U but imposes more detailed limitations, on the final gate selection and connections and therefore on the control signalling, than the quantum circuit architecture U′. For example, within the context of a particular circuit architecture, some circuit compilations may require a greater number of gates, and in particular a greater number of multi-qubit gates, than others. The specific quantum gate selection U″ is an instance of the quantum circuits U″ in which all parameters take definite values to execute, approximately, the unitary operator U for that specific problem. For example, the specific quantum gate selection U′″ may implement the qubit wavefunction for representing a specific molecular wavefunction, while the more general set of compiled circuits U″ and the yet more general quantum circuit architecture U′ may provide advantageous sets of limitations on the representation of the unitary operator U (i.e. limitations on the control system/coding for implementing particular software that is relevant to any molecular wavefunction). The quantum circuit architecture U′ and the compiled quantum circuits U″ allow some design and parameter freedom to implement the specific quantum gate selection U′″ in specific cases within a broad range of different quantum computing problems, such as the broad range of different molecules that could be simulated on a quantum computer.

Application of the specific quantum gate selection U′″ to the quantum memory manipulates the qubits into a state representative (to within a certain approximation) of the physical wavefunction V″ of interest. Improvements in the operating/control system for the quantum computer can arise from a particular choice of quantum circuit architecture U′ and/or a particular choice of quantum gate arrangement design U″. These improvements can provide for an improved balance between the precision with which the unitary operator U is ultimately represented and executed on the quantum memory and the speed and simplicity with which the process can be executed, thereby ultimately improving the signal to noise characteristics of the output of the quantum memory. These improvements can enable better technical utilisation of given quantum memory hardware, in terms of both improved accuracy of execution of software and in terms of the increased degree of complexity of software that can be effectively executed by the quantum memory hardware to provide an output with improved signal to noise characteristics.

The Energy-ordered UCC will now be disclosed in detail.

A standard starting point for calculations in Fermionic systems (such as in quantum chemistry, in which case the fermions are electrons) is the Hartree-Fock (HF) basis. It will be appreciated that other starting points corresponding to other reference states are also possible, but here the HF basis is used to exemplify the reference state. The building blocks of this basis are a discrete set of one-particle orbitals, and their one-particle energies:

E₁≤E₂≤ . . . . (1)

To an orbital i with energy Eᵢ, one associates a creation operator bᵢ^{†}, that adds one particle in i, and an annihilation operator bᵢ, that removes one particle from i.

The quantum state in which the N fermions of the system fill the first N Hartree-Fock orbitals is the Hartree-Fock state. This state is expressed mathematically as

|HF [symbol] =b_{N}^{†} . . . b₂^{†}b₁^{†}|0 [symbol] . (2)

Here |0 [symbol] represents the empty state, from which no fermions can be removed bᵢ|0 [symbol] =0.

More generally, a reference state includes a plurality of fermions that fill a first set of quantum states while a second set of quantum states remain unoccupied.

Energy-ordered-UCC comprises the architecture of quantum circuits based on the following Fermionic unitary operator U′:

U′=exp(T−T^{†}) with T=Σ_{E<E}_{_{c}}p_{E}Ô_{E}. (3)

p_{E} here are numbers—the parameters of the operator U—and T is a parameter dependent Fermionic operator based on a sum of operator strings Ô_{E}.

The parameters p_{E} may each be different for each operator string, or some subsets may be equal or proportional to each other, such as where symmetries exist in the physical system.

The operators Ô_{E} are strings of b^{†} and b operators that do not annihilate the Hartree-Fock state, e.g.:

Ô_{E}=(b_{c}_{ₘ}^{†} . . . b_{c}_{₁}^{†}bₐ_{ₘ}. . . bₐ_{₁}), aᵢ∈[1, . . . ,N] cᵢ∈[N+1, . . . ]. (4)

Here the aᵢ indices belong to orbitals that are occupied in the HF state, and the cᵢ indices to orbitals that are unoccupied. The creation and annihilation operators are thereby associated with transitions (which in this example are excitations) between the occupied and unoccupied single particle states. Notice that this notation automatically incorporates electron number conservation (this can be relaxed straightforwardly if needed).

We define the one-particle energy E of the operator Ô_{E} in (3) as:

E=E_{c}_{₁}+ . . . +E_{c}_{ₘ}−(Eₐ_{₁}+ . . . +Eₐ_{ₘ}), (5)

where the Eᵢ are the one-particle energies of the Hartree-Fock orbitals of equation (1). In this example E≥0.

When applied to the Hartree-Fock state, U′ defines the set of states referred to herein as the ‘E-UCC ansatz’:

|ψ [symbol] =U′|HF [symbol] . (6)

This set of states is parametrised by the parameters of U′.

One could equally consider the set of states obtained by the action of U′ on a different initial state, |ψ′ [symbol] =U′|ref′ [symbol] .

As explained below in Appendix B, given a fermion→qubit encoding, and a compiler, to a Fermionic unitary there corresponds a quantum circuit.

By this map, to a parameter-dependent Fermionic unitary, there corresponds a parameter-dependent quantum circuit, or equivalently, a set of quantum circuits (instances of this set are given by specific values of the parameters). This set of circuits share an architecture, as described above (i.e., they all come from the same parameter-dependent Fermionic unitary).

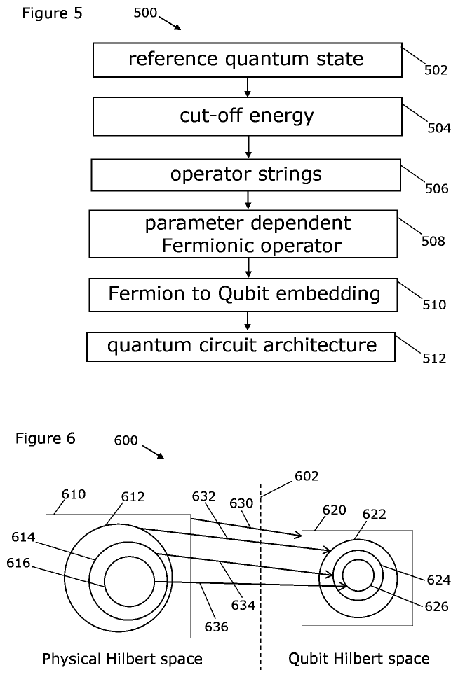

FIG. 5 shows a procedure for constructing the E-UCC class of circuits, as detailed below.
At step one 502, on a Fermionic system (e.g., a chemical system), apply the Hartree-Fock method to obtain the reference Hartree-Fock orbitals {i} and energies {Eᵢ}. (This method is efficiently implementable on a classical computer but could also be implemented on a quantum computer).
At step two 504 select a cut-off energy E_{c} with any desired criterion.
At step three 506 generate a desired number of operator strings O_{E} (eq. (4)) with energy E<E_{c} (eq. (5)).
At step four 508, construct the set of operators U of the form (3), with O_{E} in eq. (4) and E as in eq. (5).
At step five 510, choose a fermion→qubit encoding.
At step six 512 choose a quantum compiler and construct the quantum circuits corresponding to U.

Optionally, an additional step (not shown in FIG. 5) would include running the VQE algorithm to optimise over the parameters of the quantum circuit.

The E-UCC ansatz can achieve chemical accuracy (the required standard of accuracy for computational chemistry) with fewer parameters than other ansatz. This is of key importance in VQE-like algorithms. VQE searches for the minimum energy state in a given space of parameters, and the cost of this search increases steeply with the number of parameters; therefore, it is advantageous to work with as few a number of parameters as possible.

The mechanism by which E-UCC attains better accuracy arises because the most relevant states for a good approximation to the ground state are the states that by some measure already have low energy. The one-particle energy of the excitations of the Hartree-Fock state provides one such measure which can be computed cheaply.

In summary, the E-UCC ansatz (3) is generated by the operators O_{E} with one-particle energy (5) less than a pre-selected cut-off value E_{c}≥0. The cut-off value can be defined based on a difference between the sum of energies of the filled states and the sum of energies of the unoccupied states.

A classical computing system, having determined the quantum circuit architecture, can then transmit a particular quantum circuit design of the quantum circuit architecture to the quantum computer. This can enable configuration of the quantum circuit and application of the quantum circuit to a quantum memory comprising the reference quantum state stored in a plurality of qubits of the quantum computer to render the qubits into a state representative of a physical wavefunction of interest. Thereby, the quantum state can be manipulated to perform the information processing functionality of the quantum computer. Circuitry representative of a Hermitian operator can then be applied to the quantum memory. Then a plurality of qubit measurement values of the plurality of qubits can be determined and transmitted back to the classical computer system for post-processing.

Post-processing of the qubit measurement values can enable the classical computer system to estimate expectation values of a quantum mechanical (Hermitian) operator of the physical system. The classical computer can then vary one or more of the parameters p_{E} and estimate an optimized-eigenvalue of the quantum mechanical operator by successively controlling the quantum computer to prepare one or more varied quantum circuits of the quantum circuit architecture and apply each in turn of the one or more varied quantum circuits to the quantum memory containing the reference quantum state.

The cut-off energy E_{c} can also advantageously be varied in order to improve the signal to noise ratio of qubit measurement values. Successive measurements of qubit values for a given cut-off energy E_{c} will show a spread of values associated with noise processes within the quantum computer. However, some values of the cut-off energy E_{c} will show a tighter distribution of values as signal is maximised relative to noise. Larger values of the cut-off energy E_{c} will result in the inclusion of larger numbers of excitations, which provides for a better approximation to the relevant Unitary operator, but at the cost of greater complexity and measurement time, which increases noise. Alternatively, a small energy cut-off E_{c} will provide for lower noise as a result of the smaller number of excitations, but at the cost of providing for a less accurate value of the relevant expectation value. By varying E_{c} it is possible to determine an improved (or even optimised) choice of energy cut-off to balance the accuracy of the measurement provided by the quantum memory against the need to avoid excessive noise arising from the inclusion of larger numbers of excitations. This variation process can, therefore, advantageously improve the performance of the quantum computer.

FIG. 6 shows a schematic representation 600 of different unitary operators, or equivalently of different sets of quantum states corresponding to the action of the different unitary operators on a given reference state. To the left of a dividing line 602 operators/set of states in a physical Hilbert space are represented, while to the right of the dividing line 602 operators/sets of states in a qubit Hilbert space are represented.

It will be appreciated that the operators/sets of states represented in FIG. 6 are represented in a purely schematic way, which facilitates understanding of the set-subset relationships between these objects in the form of a Venn diagram.

A first set of physical quantum states 610 is represented in the physical Hilbert space as a rectangular locus. A corresponding first set of qubit states 620 is also represented by a rectangular locus in the qubit Hilbert space. In principle, a first mapping 630 between the first set of physical quantum states 610 and the first set of qubit states 620 may be an isomorphism. However, given the finite precision with which qubits can be manipulated, it may not be physically possible to render a quantum memory into the exact set of states corresponding to the first set of qubit states 620. Therefore, some approximation to the first set of physical quantum states is needed.

A second set of physical quantum states 612 is represented as a circular locus that forms a subset of the first physical quantum states 610. The second set of physical quantum states may be a set of ansatz states, such as those of a UCC(SD) ansatz, or of a higher-order approximation such as a UCC(SDTQ) ansatz. It may be possible to represent the second set of physical quantum states 612 as a second set of qubit states 622 on a quantum memory. The mapping 632 between the second set of physical quantum states and the second set of qubit states may not be isomorphic as some information loss may occur when approximating the second set of physical quantum states 612 by the second set of qubit states 622. Even so, the second set of qubit states 622 may be too complex for a given physical quantum computer to be able to process without an unacceptable level of errors/noise.

A third set of physical quantum states 614 and a fourth set of physical quantum states 616 can be represented via a third mapping 634 and a fourth mapping 636 respectively as a third set of qubit states 624 and a fourth set of qubit states 626 respectively. The third set of qubit states 624 corresponds to the E-UCC ansatz with a given energy cut-off, while the forth qubit states 626 correspond to the E-UCC ansatz with a smaller energy cut-off than that of the third set of qubit states 624. The fourth set of qubit states 626 forms a subset of the third set of qubit states 624, which in turn forms a subset of both the first 620 and second 622 sets of qubit states. It will be appreciated that, in general, the set of E-UCC ansatz states will not bear a simple relationship to the states of a UCC ansatz at a particular level of approximation (such as UCC(SD)). However, in this example 600, the particular E-UCC states 614, 616, 624, 626 are subsets of the UCC states 612, 622.

The unitary operators that correspond to the qubit states can be regarded as approximations to the unitary operator corresponding to the first set of physical quantum states. These are approximations in the sense that they relate to subsets of the first set of physical quantum states 610. In seeking to execute software on a quantum computer, improved results may be achieved by selecting an appropriate level of approximation to the first set of physical quantum states 610, and providing control signalling to the quantum computer to prepare and then manipulate the appropriate qubit states, such as the third 624 or forth 626 qubit states, where either the third 624 or fourth 626 qubit states may be preferred depending on the balance of physical characteristics present in the physical quantum computer to be utilized for executing the software.

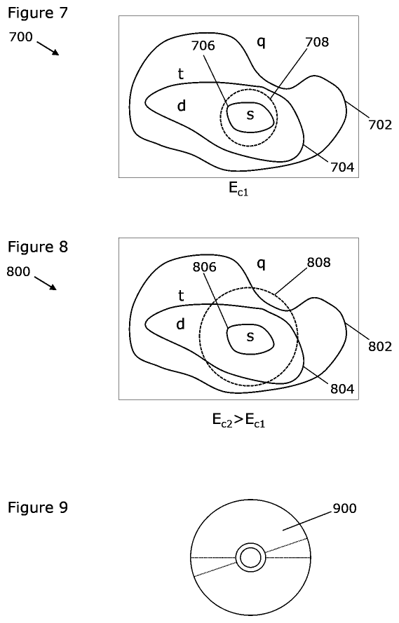

FIG. 7 shows a schematic diagram 700 of sets of quantum excitations in the context of a UCC ansatz. Excitations outside of a first contour 702 correspond to quadruples or higher order excitations. Excitations between the first contour 702 and a second contour 704 correspond to triples, while excitations between the second contour 704 and a third contour 706 correspond to doubles. Excitation within the third contour 706 correspond to singles. A dotted line 708 shows the contour that defines the set of excitations used for a first E-UCC ansatz with a first energy cut-off E_{c1}. It can be seen that the first E-UCC ansatz is based on all of the single excitations and some but not all of the doubles. In other examples, the cut-off energy E_{c} may be set at a level whereby some of the singles are not included within the E-UCC, while other higher excitation may or may not be included, depending on the energies of those excitations relative to the particular cut-off energy E_{c} chosen.

FIG. 8 is similar to FIG. 7 and similar features have been given similar reference numerals and will not necessarily be discussed further here. A dotted line 808 shows the contour that defines the set of excitations used for a second E-UCC ansatz with a second energy cut-off E_{c2} that is greater than the first energy cut-off E_{c1}. It can be seen that the second E-UCC ansatz includes all of the single excitations and some, but not all of the doubles, triples and even quadruples. In other examples, depending on the energies of each of the different excitations relative to a particular cut-off energy E_{c} it is possible that some but not all singles may be included in the E-UCC, while some higher-order excitations such as doubles, triples and quadruples etc., may be included.

The second E-UCC provides for a more accurate representation of (or approximation to) the physical quantum energy eigenstates of a physical system of interest. The second E-UCC may provide for optimized results when run on a relatively more accurate (low error-rate, low quantum noise, long coherence time) quantum computer, whereas the first E-UCC may provide for optimized results when run on a relatively less accurate quantum computer. The results obtainable by the less accurate quantum computer may generally be less accurate than those obtainable by a more accurate quantum computer, however, the less accurate quantum computer may still obtain better results when controlled in accordance with the first energy cut-off E_{c1} than if the same computer is controlled in accordance with the second energy cut-off E_{c2}. Methods of the present disclosure thereby provide for a more intelligent selection of excitations to include in an ansatz and thereby for more intelligent control signalling for quantum computers that can optimize their performance based on the physical characteristics of the quantum computer hardware concerned. In particular, these methods enable a non-obvious selection of high-order excitations for the formation of a unitary operator/software for a quantum computer, where conventional methods may instead focus on expanding the number of lower order excitations that provide lesser advantages in terms of signal to noise characteristics.

In general, where a Unitary operator is executed on a quantum memory and then a Hamiltonian operator is executed on the same quantum memory, a more accurate measurement of an energy eigenvalue will result in a lower energy eigenvalue, closer to the Full Configuration Interaction energy value. However, inclusion of too many excitations (by setting the energy cut-off E_{c} at too high a level) will result in excessive noise, which will degrade the performance of the measurements and cause the energy eigenvalues to become unreliably noisy, or impossible to recover where decoherence occurs. The precision potentially available by increasing the number of excitations (by increasing E_{c}) can be balanced against a ‘law of diminishing returns’ as the inclusion of larger numbers of excitations results in disproportionate increases in noise.

Methods of the present disclosure can determine control signalling for a quantum computer, and in particular for controlling the manipulation of qubits within the quantum computer's memory. The control signalling can be regarded as representative of the quantum circuits determined by the present methods, and vice versa. The control signalling corresponds to a representation of a unitary operator relevant to the physical system, the wavefunction of which can be encoded in the qubits by operation of the unitary operator. As the unitary operator is more accurately approximated (by a larger number of excitations, allowed by increasing E_{c}) the effects of errors and decoherence also increase, thereby counteracting the advantages of the more accurate representation of the unitary operator. Optimisation of E_{c} can thereby improve the performance of the information processing functionality of the quantum computer, such as by enhancing signal to noise ratios. Such enhancements can make the quantum computer a better performing device, based on the appropriate computer-implementation of methods of the present disclosures.

FIG. 9 shows a computer program product 900 (or computer readable memory medium) comprising instructions that, when executed by a computing apparatus, can perform any method according to the present disclosure. Methods of the present disclosure can be computer-implemented methods.

The following sections provide some specific examples and details of implementations of the present disclosure.

### Appendix A: Quantum Chemistry on Quantum Computers

Quantum computational chemistry comprises the use quantum computers to study electrons in molecules. Since the fundamental memory unit in a quantum computer is the qubit, the first step is a protocol to store electronic states in qubit memory.

States of N electrons can be described in ‘first quantisation’ as completely antisymmetric wavefunctions of their positions and spins, ψ(x₁,s₁; . . . ; x_{N},s_{N}). Since the quantum computer is digital, while the description in terms of the wavefunction is continuous, one needs to implement a discretisation to store the electronic state in qubit memory. One possibility is to discretise space with a lattice grid.

In ‘second quantisation’, electronic states are described by occupation numbers of ‘molecular orbitals’. Molecular orbitals are one-electron states in the molecule, and there are infinitely many of them; but it is a good approximation to use only a finite number. To a set of M such orbitals one associates a set of anticommuting operators:

{bᵢ,bⱼ}=0, {bᵢ,bⱼ^{†}}=δᵢⱼ, i,j=1, . . . ,M, (7)

and considers the Fock space generated by the b^{†} operators on the Fock vacuum bᵢ|0 . . . 0 [symbol] .

The quantum state of N electrons is then described as an excitation of the vacuum:

|ψ [symbol] =Σ_{{n}_{₁}_{, . . . ,n}_{_{N}}_{}}cₙ_{₁}_{. . . n}_{_{N}}bₙ_{₁}^{†} . . . bₙ_{_{N}}^{†}|0 . . . 0 [symbol] , (8)

where nᵢ=1, . . . , M belongs to the set of orbitals. The anti-symmetry of the state (8) is automatically implemented by the anticommutation rules (7).

The Fock space of M orbitals is 2^{M}-dimensional (and the Hilbert space of N electrons, eq. (8), is (_{N}^{M})-dimensional). This non-polynomial scaling makes it unfeasible to store large electronic states classically. By contrast, in a quantum computer, such states can be stored in M qubits. For example, in the so-called Jordan-Wigner encoding, each qubit is associated with the occupation number of each orbital. It is possible to encode the electronic state bᵢ^{\}|0 . . . 0 [symbol] as the qubit state

|0 [symbol] ₁⊗ . . . ⊗|0 [symbol] ᵢ₋₁⊗|1 [symbol] ᵢ⊗|0 [symbol] ᵢ₊₁⊗ . . . ⊗|0 [symbol] _{M}. (9)

Another widely used encoding is the so-called ‘parity encoding’, in which one stores in qubit j the sum of the occupation numbers (mod 2) of the i≤j orbitals. Hence, the state bᵢ^{†}|0 . . . 0 [symbol] reads

|0 [symbol] ₁⊗ . . . ⊗|0 [symbol] ᵢ₋₁⊗|1 [symbol] ᵢ⊗|1 [symbol] ᵢ₊₁⊗ . . . ⊗|1 [symbol] _{M}. (10)

Other possible encodings are Bravyi-Kitaev and Bravyi-Kitaev tree, in which qubit j generically stores the parity of nearby orbitals i≲j.

Each of these encodings entails a unitary map between the Hilbert space of fermions and the Hilbert space of qubits, and this map applies not only to states, but also to unitary operations. So, given an encoding, to every Fermionic operator one associates a qubit operator.

In NISQ implementations of quantum computational chemistry, one wants to store in qubit memory a quantum state defined by a polynomial (in M) number of parameters. The advantage of quantum computers is that they can efficiently store states that spread over non-classical regions of the Hilbert space—that is, with support over a large number of basis states. Due to this large spread over Hilbert space, these states cannot be stored in classical memory. But, since they are defined by a small number of parameters, these parameters can be stored, and manipulated, classically.

There are several strategies for defining such electronic states. One of them is the so-called unitary-coupled cluster (UCC) ansatz:

|ψ [symbol] =e^{T-T}^{^{†}}|ref [symbol] , (11)

where |ref [symbol] is a ‘classical’ reference state (e.g., the Hartree-Fock state, see sec. A.1), and

T=Σcᵢⱼbᵢ^{†}bⱼ+cᵢⱼₖₗbᵢ^{†}bⱼ^{†}bₖbₗ+ . . . . (12)

We can interpret the operator T−T^{†} as exciting orbitals from the reference state. A commonly used approximation truncates T to the order we have written it, in which case the ansatz (12) is called UCC singles-doubles (UCCSD). Notice that in this approximation the number of parameters needed to describe the state scales as (M−N)²·N²−the number of cᵢⱼₖₗ parameters (as creation operators b^{†} must be in the unoccupied orbitals and annihilation operators b in the occupied ones in the reference state).

### A.1 the Hartree-Fock Method

The Hartree-Fock method is a standard starting point in computational chemistry. It constructs an approximation to the ground state of a Fermionic system, e.g. electrons in a chemical system. This is a ‘mean field’ approximation, in which each electron is treated separately, and their interaction with the other electrons is treated on average. The output of the method is a set of one-particle orbitals, (i), and their ‘energies’:

E₁≤E₂≤ . . . E_{M} (13)

Since these orbital energies do not take into account detailed interactions between multiple particles, it is appropriate to refer to them as one-particle, or mean-field energies.

Given N fermions, the state of least energy in this mean-field approximation is the so-called Hartree-Fock state:

|HF [symbol] =b_{N}^{†} . . . b₁^{†}|0 [symbol] (14)

The Hartree-Fock method can thus be seen as an optimizer for the state of least energy within the class of states of eq. (14) and is efficiently implementable on a classical computer.

### Appendix B: Fermionic Ansatz as Quantum Circuit Architecture Classes

The purpose of this section is to explain that the seemingly ‘mathematical method’ disclosed above defines an architecture class of quantum circuits given (i) a fermion qubit mapping, and (ii) a quantum compiler as further disclosed below.

### B.1 Quantum Circuit Compilation and the Gate Paradigm of Quantum Computation

In quantum mechanics, the state of a system is an element of a Hilbert space. Transformations between states are described by ‘unitary operators’ on the Hilbert space. For example, the change in the state of a system with time is described by a specific unitary operator: the time evolution operator.
The quantum system in a quantum computer is the quantum memory unit. This memory is typically idealised as a collection of qubits: quantum systems with two completely distinguishable states. The operations on quantum memory (i.e., the elementary quantum computations) are described, abstractly, by unitary transformations on the Hilbert space of the quantum memory.
In the circuit model of quantum computation, only a few elementary operations on quantum memory are directly available: ‘quantum gates’. To implement a certain unitary operator in quantum memory, one then needs to decompose the unitary into a sequence of quantum gates: a quantum circuit. This is always possible if the set of available quantum gates is “universal”. An example of a universal set of gates in the Hilbert space of multiple qubits are general 1-qubit gates and the CNOT gate (which involves 2 qubits).
The decomposition of a unitary operator into a quantum circuit is not unique. A set of rules by which such gate decomposition is achieved is appropriately called a quantum compiler. The compilation of generic unitaries to a prescribed accuracy involves exponentially long circuits of quantum gates.
A set of quantum circuits with common features forms an ‘architecture class’. We invent an architecture class of quantum circuits whose shared features are more simply described in terms of the unitary operator they represent.
The E-UCC ansatz results in classical and quantum resource savings and accuracy gains in the VQE algorithm.

### B.2 VQE as an Optimal Quantum Circuit Finder

The Variational Quantum Eigensolver (VQE) is an algorithm for finding an optimal circuit within an architecture class. The quantity to be optimised can be, for example, a notion of energy of the state of the quantum memory. VQE can find the circuit U_{c}(θ̅) (U′″ in the notation of FIG. 4) that, when applied to a reference state |ref [symbol] , prepares the state of least energy U_{c}(θ̅)|ref [symbol] that can be prepared from |ref [symbol] using quantum circuits in the architecture class {U_{c}(θ)} (U′ in the notation of FIG. 4).

More prosaically, given a family of parameter-dependent circuits U_{c}(θ), VQE is an algorithm for finding the optimal parameter θ̅ for a certain figure of merit relating to the quantum circuits.

### Appendix C: Detailed Illustration of E-UCC with a Simple Example

This section illustrates the application of the invention in a simple example.

The example is a non-relativistic system of 6 electrons whose Hartree-Fock solution is a set of 10 uniformly spaced spatial orbitals. In appropriate units, and after discarding the offset, their one-particle energies are:

E₀=0, E₁=1, . . . E₉=9. (15)

Each of the spatial orbitals i has a capacity of two electrons: one spin up, and one spin down.

Notice that the labelling of the Hartree-Fock orbitals in this section differs from the previous one. For this system, the subindex i of (13) has two components (spatial orbital and spin), and the lowest spatial orbital is by indexed 0. The analog to (13) now is: E_{0↑}=E_{0↓}<E_{1↑}=E_{1↓}< . . . <E_{9↑}=E_{9↓}.

The Hartree-Fock state is:

|HF [symbol] =b_{2↑}^{†}b_{2↓}^{†}b_{1↑}^{†}b_{1↓}^{†}b_{0↑}^{†}b_{0↓}^{†}|0 [symbol] . (16)

The E-UCC ansatz organizes excitation operators of |HF [symbol] by their single-particle energy. The transition of least energy has E=1, and excites one electron from orbital 2 to orbital 3. Requiring this operator to conserve spin, it reads:

Ô₁=b_{3↑}^{†}b_{2↑}+b_{3↓}^{†}b_{2↓}. (17)

At energy E=2 there exist 3 operators, corresponding to exciting one electron from orbital 2 to 4; one electron from 1 to 3; or two electrons from 2 to 3:

Ô_{2,1}=b_{4↑}^{†}b_{2↑}+b_{4↓}^{†}b_{2↓},

Ô_{2,2}=b_{3↑}^{†}b_{1↑}+b_{3↓}^{†}b_{1↓},

Ô_{2,3}=b_{3↑}^{†}b_{3↑}+b_{3↓}^{†}b_{2↓}. (18)

At energy E=3 there exist 5 operators:
3 single-electron excitations (2→5; 1→4; 0→3); and
2 double-electron excitations (2+2→3+4; 2+1→3+3).

At energy E=4 there exist 9 operators:
3 single-electron excitations (2→6; 1→5; 0→4); and
6 double-electron excitations (2+2→4+4; 2+2→3+5; 2×(1+2→3+4); 1+1→3+3; 0+2→3+3. The factor 2× indicates two independent spin-conserving operators associated to that orbital transition.).

At energy E=5 there exist 13 operators:
3 single-electron excitations (2→7; 1→6; 0→5);
9 double-electron excitations (2+2→4+5; 2+2→3+6; 1+2→4+4; 2×(1+2→3+5); 1+1→3+4; 2×(0+2→3+4); 0+1→3+3); and
1 triple-electron excitation (1+2+2→3+3+4).

In E-UCC, the first double-electron excitation operator appears within the first 4 operators. In conventional UCC methods all singles excitations would be included before considering doubles excitations. In this ranking, the first double operator would have appeared as the 22nd operator. Similarly, in E-UCC a triple excitation arises within the first 31 operators. This system has 231 doubles excitations, so in conventional UCC the first triple would arise as the 253rd operator.

It is noteworthy that E-UCC provides a significant reordering of the ranking of relevance of operators compared to UCC.

### Appendix D: Case Study BeH₂

In this section we benchmark the application of E-UCC to a particular system: the BeH₂ molecule. We study the molecule in its linear configuration, in which the Be nucleus sits in the middle, at a distance of 2.54 Bohr from each of the H nuclei.

The system has 6 electrons, and we work with 7 spatial orbitals, that is 14 spin-orbitals once we account for the spin degree of freedom. The 7 orbitals can be thought of as coming from the 1s atomic orbital of each H atoms, and the 1s, 2s and three 2p orbitals of the Be atom. In the approximation of keeping only 7 spatial orbitals, the ground state of Hamiltonian of the system can be found exactly. Its energy (measured in Hartrees [1 Ha=627.509 kcal/mol.]) is:

E_{FCI}=−15.34855639 Ha. (19)

We will benchmark to this energy—even if it is approximate because we have kept only 7 spatial orbitals out of the infinitely many.

The Hartree-Fock energy is:

E_{HF}=−15.14955666 Ha. (20)

It stands out that the Hartree-Fock energy is not chemically accurate; chemical accuracy requires agreement with E_{FCI} within 3 decimal places (Historically, the term ‘chemical accuracy’ refers to a certain degree of compatibility between calculations and measurements. Instead, here it means “distance to the FCI energy of less than 10⁻³ Ha. or equivalently 4.36×10⁻²¹ J”).

The UCCSD ansatz on this system has, after exploiting symmetries, 23 parameters (3 singles, 20 doubles). Its minimum energy is:

E_{UCCSD}=−15.3362925 Ha. (21)

Notice that this is not chemically accurate.

By contrast, E-UCC, truncated at energy E_{c}=1.9 Ha, has 22 parameters (2 singles, 10 doubles, 6 triples, 4 quadruples), and its minimum energy is

E_{E-UCC}=−15.3481995 Ha, (22)

that is chemically accurate.

It stands out that, with a similar number of parameters to UCCSD, E-UCC is much more accurate in this molecule.

### Appendix D: Application to Nuclear Physics

It will be appreciated that techniques of the present disclosure apply to other problems involving fermions (particles of half-integer spin), for example to nuclear physics because nucleons (both protons and neutrons) have spin ½. Furthermore, other Fermionic fundamental particles can also be analyzed in accordance with examples of the present disclosure.

The present disclosure provides an advantageous ansatz for post-Hartree-Fock computations with quantum computers. Given a fermion→qubit encoding, and a quantum compiler, this ansatz characterises an architecture class of quantum circuits. This ansatz/architecture class outperforms previous ansatz in variational tasks such as VQE, as it achieves chemical accuracy in parameter spaces of lower dimensionality than other ansatz—resulting in resource savings both in (i) the quantum state preparation part of the VQE algorithm, and in (ii) the optimisation step.

1. A computing system for determining a quantum circuit architecture, for a quantum computer, based on a physical system comprising a plurality of fermions, wherein the computing system comprises a classical computing system configured to:
receive a reference quantum state for the physical system in which the plurality of fermions occupy a first set of single-particle quantum states of the physical system and in which a second set of single-particle quantum states are unoccupied;
receive a cut-off energy that is greater than an absolute value of a difference between (i) a sum of energies of the second set of single-particle quantum states, and (ii) a sum of energies of the first set of single-particle quantum states;
determine a Fermionic Unitary Operator based on a parameter dependent Fermionic operator, wherein the parameter dependent Fermionic operator comprises a sum of products of:
(i) an operator string; with
(ii) a parameter for the operator string;
wherein each operator string of the sum of products is formed from respective creation and annihilation operators and is associated with a respective transition of one or more of the plurality of fermions from the first set of single-particle quantum states to one or more of the second set of single-particle quantum states, each respective transition having a transition energy less than the cut-off energy, and
determine the quantum circuit architecture based on the Fermionic Unitary Operator.

2. The computing system of claim 1, wherein the transition energy for each respective transition is determined using a Hartree-Fock method.

3. The computing system of claim 1, wherein the transition energy of each of a plurality of operator strings of the sum of products is an equal transition energy and the parameter for each respective operator string of the plurality of operator strings are proportional to each other.

4. The computing system of claim 1, wherein one or more operator strings of the sum of products are formed such that one or more quantum numbers, corresponding to symmetries of a Hamiltonian of the physical system, are conserved.

5. The computing system of claim 1, wherein the quantum circuit architecture comprises a plurality of quantum circuits, each quantum circuit of the quantum circuit architecture having a respective design that represents the Fermionic Unitary Operator having a value for each parameter for each respective operator string.

6. The computing system of claim 1, wherein the classical computing system is configured to transmit a quantum circuit design of the quantum circuit architecture to the quantum computer to enable configuration of the quantum circuit and application of the quantum circuit to a quantum memory comprising an initial quantum state stored in a plurality of qubits of the quantum computer.

7. The computer system of claim 6, further comprising the quantum computer configured to:
receive the quantum circuit design;
configure a quantum circuit according to the quantum circuit design;
apply the quantum circuit to the quantum memory containing the initial quantum state;
determine a plurality of qubit measurement values of the plurality of qubits; and
transmit the plurality of qubit measurement values to the classical computing system.

8. The computer system of claim 7, wherein the classical computing system is configured to estimate an expectation value of a quantum mechanical operator of the physical system based on the plurality of qubit measurement values.

9. The computing system of claim 8, wherein the classical computer is configured to vary the parameter for one or more of the operator strings and estimate an optimized-eigenvalue of the quantum mechanical operator by successively controlling the quantum computer to prepare one or more varied quantum circuits of the quantum circuit architecture and apply each in turn of the one or more varied quantum circuits to the quantum memory containing the initial quantum state.

10. The computing system of claim 8, wherein the quantum mechanical operator is a Hamiltonian operator.

11. The computing system of claim 10, wherein the cut-off energy is chosen such that a difference between an expectation value of the Hamiltonian operator and a Full Configuration Interaction energy of the physical system is less than 4.36×10⁻²¹ J.

12. The computing system of claim 1, wherein the Fermionic Unitary Operator is an exponential of an Anti-Hermitian operator based on the parameter dependent Fermionic operator.

13. The computing system of claim 1 wherein the reference quantum state is a Hartree-Fock quantum state.

14. The computing system of claim 1 wherein the plurality of fermions is a plurality of electrons and the physical system is a molecular system or a unit cell of a crystalline material.

15. The computing system of claim 14 configured to perform any one or more of catalyst development, drug discovery or materials development.

16. The computing system of claim 1 wherein the plurality of fermions is a plurality of nucleons.

17. A computer-implemented method for determining a quantum circuit architecture, for a quantum computer, based on a physical system comprising a plurality of fermions, the method comprising:
receiving a reference quantum state for the physical system in which the plurality of fermions occupy a first set of single-particle quantum states of the physical system and in which a second set of single-particle quantum states are unoccupied;
receiving a cut-off energy that is greater than an absolute value of a difference between (i) a sum of energies of the second set of single-particle quantum states, and (ii) a sum of energies of the first set of single-particle quantum states;
determining a Fermionic Unitary Operator based on a parameter dependent Fermionic operator, wherein the parameter dependent Fermionic operator comprises a sum of products of:
(i) an operator string; with
(ii) a parameter for the operator string;
wherein each operator string of the sum of products is formed from respective creation and annihilation operators and is associated with a respective transition of one or more of the plurality of fermions from the first set of single-particle quantum states to one or more of the second set of single-particle quantum states, each respective transition having a transition energy less than the cut-off energy, and
determining the quantum circuit architecture based on the Fermionic Unitary Operator.

18. A method for determining control signalling fora quantum computer, the control signalling configured to execute application software on the quantum computer, the application software representative of a Unitary Operator configured to operate on a wavefunction based on a physical system comprising a plurality of fermions, the method comprising:
receiving a reference signal representative of a reference quantum state for the physical system in which the plurality of fermions occupies a first set of single-particle quantum states of the physical system and in which a second set of single-particle quantum states are unoccupied;
receiving a cut-off signal representative of a cut-off energy that is greater than an absolute value of a difference between (i) a sum of energies of the second set of single-particle quantum states, and (ii) a sum of energies of the first set of single-particle quantum states;
determining a Fermionic Unitary Operator based on a parameter dependent Fermionic operator, wherein the parameter dependent Fermionic operator comprises a sum of products of:
(i) an operator string; with
(ii) a parameter for the operator string;
wherein each operator string of the sum of products is formed from respective creation and annihilation operators and is associated with a respective transition of one or more of the plurality of fermions from the first set of single-particle quantum states to one or more of the second set of single-particle quantum states, each respective transition having a transition energy less than the cut-off energy, and
determining the control signalling based on the Fermionic Unitary Operator, wherein the Fermionic Unitary Operator is representative of the Unitary Operator.

19. The method of claim 18, further comprising:
providing the control signalling to the quantum computer;
configuring the quantum computer based on the control signalling;
measuring a quantum memory of the quantum computer to provide output signalling based on the control signalling; and
iteratively varying the cut-off energy to improve a signal-to-noise ratio of the output signalling.

20. A computer program product including one or more sequences of one or more instructions which, when executed by one or more processors, cause an apparatus to at least perform the steps of the method of claim 18.
